(19) United States
(12) Patent Application Publication
(10) Pub. No.: US 2015/0127593 A1
(43) Pub. Date: May 7, 2015

(54) Platform to Acquire and Represent Human Behavior and Physical Traits to Achieve Digital Eternity

(71) Applicant: Forever Identity, Inc., New York, NY (US)

(72) Inventors: Fabrizio Gramuglio, Genova (IT); Giorgio Manfredi, Milano (IT)

(21) Appl. No.: 14/532,324

(22) Filed: Nov. 4, 2014

Related U.S. Application Data
(60) Provisional application No. 61/900,550, filed on Nov. 6, 2013.

(51) Int. Cl. G06N 3/00; G06N 5/04

(52) U.S. Cl. CPC G06N 3/006; G06N 5/04
USPC 706/12

(57) ABSTRACT

An artificial intelligence platform that is capable of reproducing a person's identity and allowing others to interact with it is described. It does so by creating a Digital Identity, founded on the very concept of a Digital Soul capable of bringing back to life (mirroring) the physical aspect, behavior, emotions, mannerisms and relational sphere of the subject. Each Digital Identity is capable of interacting with its surroundings and of formulating specific responses based on an innovative knowledge base structure of the individual, his emotional background (psychological model) and relational structure (skills/aptitude). The creation of a Digital Identity is defined by the ensemble of the individual's Digital Soul (Animus, Loquor and Indoles), physical characteristics (Corpus) and relational sphere with people (Societas) and with the environment (Circum).

### CROSS-REFERENCE TO RELATED APPLICATIONS

The present application relies on the disclosure of and claims priority to and the benefit of the filing date of U.S. Provisional Application No. 61/900,550, filed Nov. 6, 2013, the disclosure of which is hereby incorporated by reference herein in its entirety.

### BACKGROUND OF THE INVENTION

1. Field of the Invention

The present invention relates to artificial intelligence. More particularly, the present invention relates to an artificial intelligence platform for representing a human subject to one or more interlocutors through a dialogue.

2. Description of Related Art

Since the time of cave dwellers man has gone to great lengths to ensure his name, deeds and thoughts will be remembered and cherished by future generations. This need has been, in all ages, in all cultures and in all social strata, one of the key characteristics of human nature and a key driver of history. Storytellers, portrait painters, bibliographers, photographers, memorial architects have, to various degrees, tried to address this need. U.S. Pat. No. 8,156,054 entitled “Systems and Methods for Managing Interactions Between an Individual and an Entity” assigned to AT&T, which is incorporated by reference herein in its entirety, describes a system to “retrieve collected information associated with a behavior of an individual, synthesize from the information a measure of a mood of the individual to interact with others, and transmit the measure to a system associated with the individual to manage requests between the individual and the entity.” Such systems, as well as legacy, memory, and identity preservation techniques existing today, fall short of being able to provide an artificial intelligence platform capable of providing responses from the subject that are consistent with an accurate portrayal of the subject.

### SUMMARY OF THE INVENTION

To this end, the present invention provides an artificial intelligence platform able to acquire, preserve and maintain the physical and immaterial legacy of a subject in order to reproduce his/her human behavior and identity, as well as permit dynamical interactions with future generations. This platform, also known as the Digital Identity, can be applied to any kind of 2D/3D representation of the human body and, using the five senses plus perception and intuition, it can understand the environment and the people around it. It captures the simultaneous stimuli coming from different sources and defines an intelligent answer based on the computation of different engines representing the human processes of intuition and perception and the human emotional process compared to moral and ethical values. The generated answer or answers derive from a customized knowledge base containing the represented subject's memories in the form of texts, algorithms, images, sounds, videos and all the other digital representations of objects and concepts.

The generated answer can be played as dialogic mode supported by one or more of the related digital representations and can be presented in a form detectable by one or more of the five senses of the interlocutors.

Architecture of Digital Identity (DI): the system is based on six different related logical elements: Circum, Corpus, Loquor, Indoles, Animus and Societas.

Circum manages the perception of the environment external to the DI. To do this Circum manages different sensors and actuators that emulate the five human senses (hearing, sight, smell, taste, and touch). After the collection of sensorial stimuli, Circum computes this input to decide the categorization and the relevance of these stimuli. As used in the context of this specification, “Circum” may be used interchangeably with “means for sensing” or “module operably configured for sensing.”

One aspect of Circum is that it is capable of filtering the five senses stimuli by a suitable set of algorithms representing a subject's specific sensibility in order to transduce biometrical inputs into a specific sensation.

Circum is capable of describing a cognitive matrix that stimulates the DI's perceptive system, capable of acquiring the different input stimuli and transmitting them in processed form to the other elements of DI's platform in order to obtain a decision about the right answers to deliver.

To manage the perception of the environment external to the DI, Circum uses the data managed by the Multisensorial Priority Manager and the algorithms of Perception Engine and Intuition Engine.

The Multisensorial Priority Manager contains a Multimodal/Multisensorial Interface and a Multisensorial Priority Engine able to assign different priorities to perceived inputs.

The Multisensorial Priority Manager categorizes the stimuli as:
Explicit stimuli: language stimuli consciously generated by the interlocutors.
Non-explicit stimuli: language stimuli unconsciously generated by the interlocutors.
Evocative stimuli: non-language stimuli unconsciously generated by the interlocutors or by the environment.
Social stimuli: stimuli derived by the level of intimacy of the interlocutors with respect to the subject.

Other categories can be introduced in the future.

The Multimodal/Multi-sensorial Interface enables the uncoupling of the environmental inputs perceived through the sensors (actuators) and their perceptive valence thus allowing the senses and the reactions they trigger in a Digital Identity to be kept distinct from their technological actuators.

The Multisensorial Priority Engine establishes the relevance of the perceived inputs. The decisions about relevance are based on the subject's personal history, sensibility, memories and behaviors.

The Perception Engine represents the capacity of the DI to understand the non-explicit stimuli coming from the environment and mix these with the explicit stimuli, in order to obtain the best perception on the events that occur in the DI's environment. To optimize the perceptual environment, the Perception Engine uses the weight generated by the Multisensorial Priority Engine and transforms the non-explicit stimuli into explicit stimuli. The words (or tags or symbols) used to describe the non-explicit stimuli depend on the weight assigned.

The Intuition Engine represents the capacity of the DI to generate new stimuli based on the original ones plus the relevance introduced by the Multisensorial Priority Engine and the redefinition computed by the Perception Engine.

To construct an intuition, the engine uses an appropriate classification of the subject's memories where each item is connected with the others by fuzzy logic. The intuition results from the application of artificial intelligence methods applied on data and inputs.

The intuition will be detected by the interlocutors as an answer (verbal or/and non-verbal) to the previous stimuli. This process will be repeated in order to collect new stimuli for the DI. These stimuli are re-analyzed by means of the Multisensorial Priority Engine and the Perception Engine. The results, inserted in the Intuition Engine, contribute to validate or discard the intuition.

In the intuition's process an analysis of facial similarity is applied. The face of each unknown interlocutor will be compared, by biometric methods, to the faces inserted in the knowledge of the DI. If the similarity passes a threshold value, the emotional attributes of the stored faces, in the DI's knowledge, will be used to compute the intuition.

The cycles of reiteration necessary to solve an intuition are structured in a way to obtain a reinforcement learning where, at the end, the intuition is adopted or discarded.

The Societas Module is a specific relational component tied to each subject's identity and relationships that gives/limits access to each specific piece of information. The Societas Module manages the access to stored information (memories, biography, etc.) filtering on relationship values such as relatives, friends, groups and interests. As used herein, “Societas” may be used interchangeably with “means for providing a level of intimacy” or “module operably configured for providing a level of intimacy.”

Societas comprises two modules: the Permission Rules and Identity Catalogue and the Intimacy Management Engine.

The Permission Rules and Identity Catalogue contain the personal and biometrical data about the individuals identifiable by the DI. Each of these individuals is connected by a set of attributes that identify their intimacy status with the DI and its social group.

The intimacy status is an integer that identifies the Level of Intimacy (LoI) of an interlocutor with the DI. The LoI is coupled with the number of occurrences that identify the number of relations occurred between the interlocutor and the DI.

The social groups are characterized by (1) their social values which for example can include one or more of gender, range of age, race, ethnicity, citizenship, religion, social class, level of study, kind of work, and similar values, (2) their emotional appeals, and (3) their ethical and moral values. The social values can be segmented in a more refined way. The emotional appeal will be catalogued in accordance to the Indoles's emotional parameters and, for the known person, are collected in the Memories Repository. The ethical and moral values will be catalogued in accordance with the ethical and moral values adopted in the Animus.

The Intimacy Management Engine computes the Total Level of Intimacy (LoI) of all the persons in front of the DI (in relation with the DI). Specific methods and equations for determining the Total LoI are provided in more detail below. In embodiments, the Total Level of Intimacy is the output of the Societas module. The Total LoI can be used by the other modules to define the quality of answer (in terms of content and verbal and non-verbal expressions) released to the set of interlocutors.

“Vigilance” is a function that represents the weight of vigilance that the DI uses to deliver an answer. The DI computes this weight starting from the quality of connections between the interlocutor and the known network of persons. This approach permits the DI to set the LoI by means of the personal parameters of the interlocutor and the influence of this interlocutor on the social network connected with DI.

The Intimacy Management Engine computes in a recursive way the Total LoI, based on the stimuli received. It starts with a Total LoI (t₀) and it modifies this value based on the new information accumulated during the session of dialogue between the interlocutors and the DI.

The LoI of each interlocutor will be upgraded in a different way:

a) if an interlocutor is unknown, the information collected during the dialogue can modify the parameters of social group;

b) If an interlocutor is unknown, but the DI collects enough data to identify him/her in a unique way (typically biometrical data) the intimacy status is upgraded;

c) If the interlocutor is known or unknown, but he/she is endorsed by a known interlocutor with sufficient intimacy status, he/she can obtain an intimacy status upgrade;

d) If the interlocutor is known, the information collected during the dialogue can modify the parameters of social group and, eventually, the intimacy status will be upgraded;

e) If the interlocutor is known but his/her number of occurrences exceeds a defined threshold, eventually, the intimacy status will be upgraded.

The DI's subject defines all the weights, thresholds, and other elements used to determine a temporary or lasting variation of LoI.

The Indoles Module defines the specific emotional and psychological model of Digital Identity constructed from those available in the literature or tailored specifically to the user one is representing. The Indoles Module contains the n-dimensional map of the emotional states and the psychological model that defines the transition rules from one emotional status to another. As used herein, the term “Indoles” may be used interchangeably with “means for determining emotional behavior” or “module operably configured for determining emotional behavior.”

The Indoles Module transforms each Digital Identity's dialogue into an n-dimensional point into the map of emotions calculated by means of the emotional attribute of a specific stored memory.

The Indoles Module includes the parameters to set the correct facial expression and movements of body and hands for a 2D/3D representation and to set the voice synthesis.

The Indoles Module is composed of four sub-modules: the Emotional Map, the Emotional Behavior Function, the Emotional Reasoning Engine and the Emotional Representation Function.

The Emotional Map describes the possible range of emotions that the DI can assume. This map is unique for all the DIs created and summarizes the state of the art of the study on human emotion.

The Emotional Behavior Function describes the behavior of the subject into the emotional map. This function traces the possible paths that the subject can use into the map.

The Emotional Reasoning Engine computes the emotional status of the DI, with one or more of the following steps: 1) detection of the actual position in the Emotional Map; 2) reception of the input's stimuli, fitted and elaborated by Circum and Societas; 3) extraction by the Memories Repository (see below in the Animus element) of the emotional values related to the ongoing dialogue; and 4) computation of the next position in the Emotional Map function of: actual position, emotional values received from Circum, emotional values received from Societas, and emotional values extracted from Memories Repository (which in the context of this specification may also be referred to as a Memory Repository).

With the absence of any kind of stimuli, in each time interval the Emotional Behavior Function computes a new position on the emotional map.

The Emotional Representation Function separates the emotions felt by the DI from those expressed. This function uses correction parameters of emotional behavior arrived from Animus. These parameters are used to compute the new position in the Emotional Map.

The Emotional Representation Function defines the boundaries, in the Emotional Map, of the emotions that the DI is able to show.

The Animus is the representation of the subject's memories, of its capacity to compute a decision based on the data known, and his/her ethical and moral values. The Animus is structured around a storage and computing system in which the subject's memories are related to the subject's emotions, his/her sensations, his/her prosodic, lexical, moral, religious and psychological characteristics and other personal attributes connected with the memories. As used herein, “Animus” may be used interchangeably with “means for storing memories and/or deciding an answer” or “module operably configured for storing memories and/or deciding an answer.”

Animus, together with Indoles, receives data from Circum and Societas. They process these inputs and pass the results to the Loquor and Corpus for the right representation of the answers.

The memories are perpetuated and stored in the Memory Repository, a highly structured organic framework based on multiple levels of information, including one or more of:

i. the data necessary to contextualize the memory: timestamp of memory insertion, localization, timeframe of memories (age of the subject), taxonomic classification of the memory, connection with other memories and references to the different topics;

ii. the biographical memory in different form: the subject's sentences (texts), the subject's narration of an experience (texts), external documents, videos, images, verbal audios and music, etc.;

iii. Sensorial stimuli: smells, sounds, taste and flavor descriptions, tactile descriptions;

iv. The identified people involved in the memory and their affiliation, at a relationship level, to specific socio/demographic groups. This results in providing or limiting access to each specific piece of information. Thus, access to information is specific to determined circles of relations;

v. The emotional, ethical and moral values and tags, which are used, based on predetermined models, to compute the emotional and moral reaction applicable to each specific memory.

In order to protect the private data of the subjects, the Memory Repository preserves the memories using encryption techniques with public or private keys.

The memories are catalogued in the Repository by means of different ontologies related to the subject. The search (and extraction) of the memories related to an input stimulus is developed using the subjective semantic analysis of the input stimulus (see Loquor described below).

The Animus also includes different computational modules: a Moral and Ethical Module that holds the ethical and religious rules fitted to the subject and a Decisional Engine to compute the right answer.

The Decisional Engine to compute the right answer can be based on any one or more or different combinations of:

a. the input's stimuli manipulated from Circum and Societas,

b. data from the Moral and Ethical Module,

c. the emotional values computed by Emotional Reasoning Engine,

d. In addition, subject memories and biography.

This approach enables the generation of a specific response adapted to a determined situation, question and/or stimuli, even if they are already known and classified in the Animus, or never encountered before (not classified in the Animus memories or biography).

The Moral and Ethical Module is composed by two main parts: the Moral and Ethical Assertions Repository and the Moral and Ethical Inferential Engine.

The Moral and Ethical Assertions Repository is a database of sentences that define the positive or negative value of an action or a thought. The set is divided in subsets, each of these representing a collection of sentences unified by a moral. Each subject can have more than one moral (including sentences in contrast).

Modification at the standard morals or creation of new morals will be applied during the memories data collection phase.

The database of the Moral and Ethical Assertions Repository is indexed in a way to simplify the research of sentences.

The Moral and Ethical Inferential Engine (M&E Engine) searches in the indexed database of the Moral and Ethical Repository all the sentences that may be possible responses/answers/arguments provided in response to when a memory is stimulated by the inputs. The possible responses/answers/arguments are identified by the tags or by the values stored in the Moral and Ethical Repository and connected with the specific memory. The Moral and Ethical Inferential Engine applies a sentiment analysis on the sentences to evaluate the positive or negative relevance of the stimulus and of the related memories.

The results of this analysis may increase or decrease the moral and ethical relevance of the stimulus.

The Decisional Engine is an artificial intelligence (A.I.) engine able to decide the right answer, selected among the memories extracted from the Memory Repository, based on the criteria obtained from Circum, Societas, Indoles and the M&E Engine. The main steps of the process to select the best answer can include one or more of the following:

i. From Loquor, the verbal stimuli (phrases) are filtered by means of the subjective NLP;

ii. From Circum, the non-verbal stimuli (translated in textual descriptions);

iii. From the Intuition Engine the memories are recalled by the intuition (these memories have a different relevance);

iv. Using the semantic analysis, based on texts, tags and descriptions, the Decisional Engine finds, and extracts, all the memories that satisfy the received stimuli;

v. The Decisional Engine starts the computation to identify the best answer based on the selected memories. For the computation the Decisional Engine compares the output of other modules with the following attributes of each selected memory:

a. The Total LoI (output of Societas) establishes which among the selected memories are compatible with the interlocutors;

b. The outputs of Indoles that allow it to obtain the emotional status of DI related to the present stimuli and the emotional status of DI related to each memory adopted as a possible answer;

c. The outputs of the M&E Engine that permit it to recognize the moral and ethical values related to the received stimuli;

d. A dedicated algorithm compares the relevance of the emotional impact of the stimuli, and the related memories, with the relevance of their own moral impact. This algorithm is set by psychologists during the analysis of the subject's personality phase of the DI configuration;

e. The algorithm's result can modify the Total LoI value. In this case the steps b will be repeated and if a new set of selected memories is obtained, the steps c and d will be repeated to obtain a stable result.

Loquor: a module for expressing answers and reactions of the subject represented by the Digital Identity. The Loquor module represents the dialogical capacities of the Digital Identity. This capacity is split into two main branches: one devoted to understand the verbal and non-verbal languages of the interlocutors and the other one to express, by means of verbal and non-verbal languages, the answers and reactions to the input stimuli from the environment and the interlocutors. As used in this specification the term “Loquor” may be used interchangeably with “means for expressing” or “module operably configured for expressing answers and reactions.”

Non verbal languages, pauses and prosody can be influenced by components of the persona, where language inflection is influenced by the relational apparatus and will therefore reflect the user's affiliation/belonging to a specific social structure.

Subjective NLP Service and Ontologies are devoted to the identification of meaning of an input's stimuli and its capability for creating a connection with the individual's ontologies of the Digital Identity. To obtain this, the Loquor: a) receives the input (verbal or text) and, by means of a Subjective NLP Service and Subjective Ontologies, understands the “common meaning” and the “intimate meaning” of the phrases and b) solves by means of searches and extractions of content from the subject's memories (e.g. memories represented in the Memories Repository).

A multi-level catalogue of the different ontologies related to the subject is created where the native language spoken by the subject (Language Ontology) is mandatory. In addition, other optional ontologies are created: one dedicated to the subject's individual expertise and environment (Cultural-Group Ontologies), those regarding social dialogue (Social Dialogue Ontology), and those created especially for a specific user (User Ontology). A subjective NLP service uses the previous ontologies to understand the “common meaning” and the “intimate meaning” of the verbal and non verbal messages.

The Subjective NLG Service and the Related Library are devoted to express, by means of verbal and non verbal languages, the DI's answers and reactions and are connected with the NLG (Natural language Generation) service. The main components of this branch are the different kinds of libraries:

i. the library of phonemes for the Text-To-Speech customized on the subject;

ii. the library of the facial expression, customized on the subject.

Both the libraries have some special add-on:

iii. Prosody is a matrix that transforms the emotions (received from the Emotional Representation Function) into sequences of verbal and non-verbal elements selected from the libraries;

iv. Idioms & Jargon Maps are special sub-libraries that collect the typical expressions of the subject represented by the Digital Identity. Similarly to the NLP branch, Idioms & Jargons Maps are divided into five categories: universals, locals, sectorial, relatives and personals.

The DI can change the level of formality of the output language based on the DI behavior, the argument being made, and the interlocutors. The default is a more nested (personal) lexicon and according to the context level, it rises towards a broader level. It is therefore necessary that each element of the nested lexicon must have semantic correspondence to the upper level. The Subjective NLG Service can decide when and how much information is lost compared to how much is understood by the interlocutor by lowering the level of formality.

The Digital Identity, through Circum, Societas, Indoles, Animus and Loquor, aims to provide an answer that is consistent with the subject's know-how, personality, knowledge, and with his/her will, and, overall, ensures that the process of understanding the questions and of the stimuli is tailored around to the subject's experience.

The Presentation layer (Corpus), or interface, of each Digital Identity will be a hyper-realistic representation of the user. It will be obtained through different advanced techniques capable of best representing both the physical characteristics (bone, muscle and the skin) and the voice (inflection, changes in tone, etc.) of the subject. As used herein, the term “Corpus” may be used interchangeably with “means for representing” or “module operably configured for representing one or more characteristic of the subject.”

The presentation layer can be static or can change in time. It can move (change emotion, voice inflection, posture and gesture) based on the indications it is given by the Animus and by the dialogical state.

The presentation layer communicates with the Animus through a communication protocol that enables the decoupling of the presentation layer, technology dependent, from the decisional one tied to the Animus.

### BRIEF DESCRIPTION OF THE DRAWINGS

The accompanying drawings illustrate certain aspects of embodiments of the present invention, and should not be used to limit or define the invention. Together with the written description the drawings serve to explain certain principles of the invention.

FIG. 1 is a schematic diagram showing representative Digital Identity (DI) logical elements according to embodiments of the invention.

FIG. 2 is a schematic diagram showing how the environment may interact with the DI according to embodiments.

FIG. 3 is a schematic diagram showing a representative way in which the Societas and the environment may interact and showing how this interaction may influence the DI's answers.

FIG. 4 is a schematic diagram showing a representative way in which the Indoles and other elements may interact and how this interaction may be used to influence the DI's answers.

FIG. 5 is a schematic diagram showing representative relationships between Animus and other modules.

FIG. 6 is a schematic diagram showing representative relationships between Loquor and other modules.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

The present invention introduces a new platform able to create, manage and preserve a dynamic legacy (called “Digital Identity” or “DI”). The platform is able to acquire, preserve and maintain the physical and immaterial legacy of a subject in order to reproduce their human behavior and identity and permit dynamical interactions with future generations.

The Digital Identity can be applied to any kind of 2D/3D representation of the human body and, using one or more of the five senses plus perception and intuition, can understand the environment and the people around it. It captures the simultaneous stimuli coming from different sources and defines an intelligent answer based on the computation of different engines representing the human processes of intuition and perception and the human emotional process compared to moral and ethical values. The generated answer(s) are derived from a customized knowledge base containing the representative subject's memories in the form of texts, algorithms, images, sounds, videos and all the other digital representations of objects and concepts.

The generated answer will be played as dialogic mode supported by all the related digital representations and presented in a form detectable by one or more of the five senses of the interlocutors.

Systems of the present invention may include a processor, such as a central processing unit or a graphics processing unit or both. The systems may comprise memory for storing data and/or instructions for operating the system. A computer is preferably used to process the data and to facilitate interaction between the subject and an individual. Such systems can comprise a video display, speakers, a keyboard, a mouse, disk drive, and/or microphone for facilitating the interactions. The computer can be configured for processing such information over a network, such as the internet. Processing instructions for implementing any one or more of the operations outlined in this specification can be stored on a machine-readable medium. In the context of this specification, a machine-readable medium is understood as any medium capable of storing or encoding a set of instructions capable of performing any one or more processes outlined in this disclosure and can include for example a memory card, a hard drive, a read-only memory, random access memory, a disk or tape, or a digital file for example. Systems and methods disclosed in this specification are intended as software programs to be executed by a computer processor. For example, one or more method steps of any method described herein can be provided as executable instructions and can be embedded on physical media, such as a hard drive or compact disc or jump drive, etc., and executed by a computer processor.

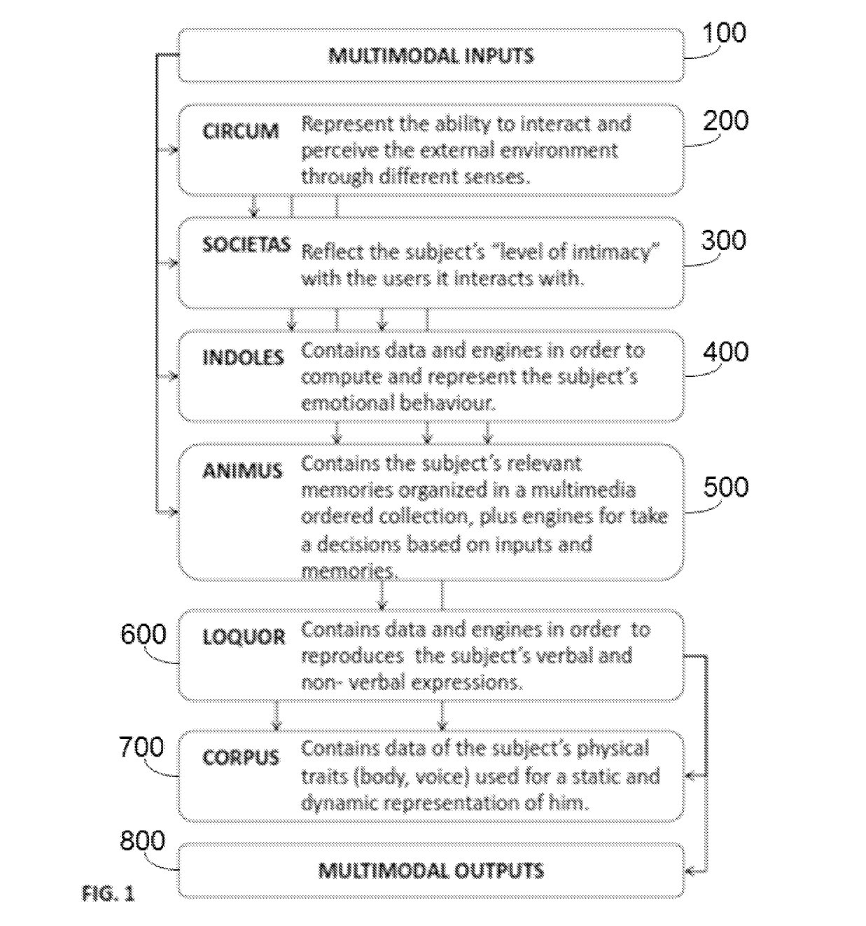

Specifically, in one embodiment a DI is made up of one or more or preferably all six main logical elements as shown in FIG. 1: Circum 200, Societas 300, Indoles 400, Animus 500, Loquor 600 and Corpus 700. The DI receives Multimodal Inputs 100, which pass to the Circum 200, Societas 300, Indoles 400, and Animus 500. These components pass outputs to the Loquor 600 and Corpus 700, which pass Multimodal Outputs 800 from the DI.

First element of Digital Identity (DI): Circum 200. DI can work using holograms, touchscreens, integrated in robots technologies or integrated in a web social platform.

The first logical element of the DI is the Circum 200: this element manages the perception of the environment external to the DI. In order to function this way, the Circum 200 manages different sensors and actuators that emulate the five human senses (hearing, sight, smell, taste, and touch). After collection of sensorial stimuli, the Circum 200 computes this input in order to categorize and decide relevance of these stimuli.

The Circum 200 could integrate a new approach of perception and intuition where the five senses are not only determined by biometrical parameters, but they are also filtered by a suitable set of algorithms representing a subject's specific sensibility in order to transduce biometrical inputs in a specific sensation (for example: he experienced the smell of fear).

Other than being able to perceive and analyze input in the above-described manner, this module can interact with the environment and generate an answer (based on up to 5 senses) which is then transmitted through its multimodal/multi-sensorial interface.

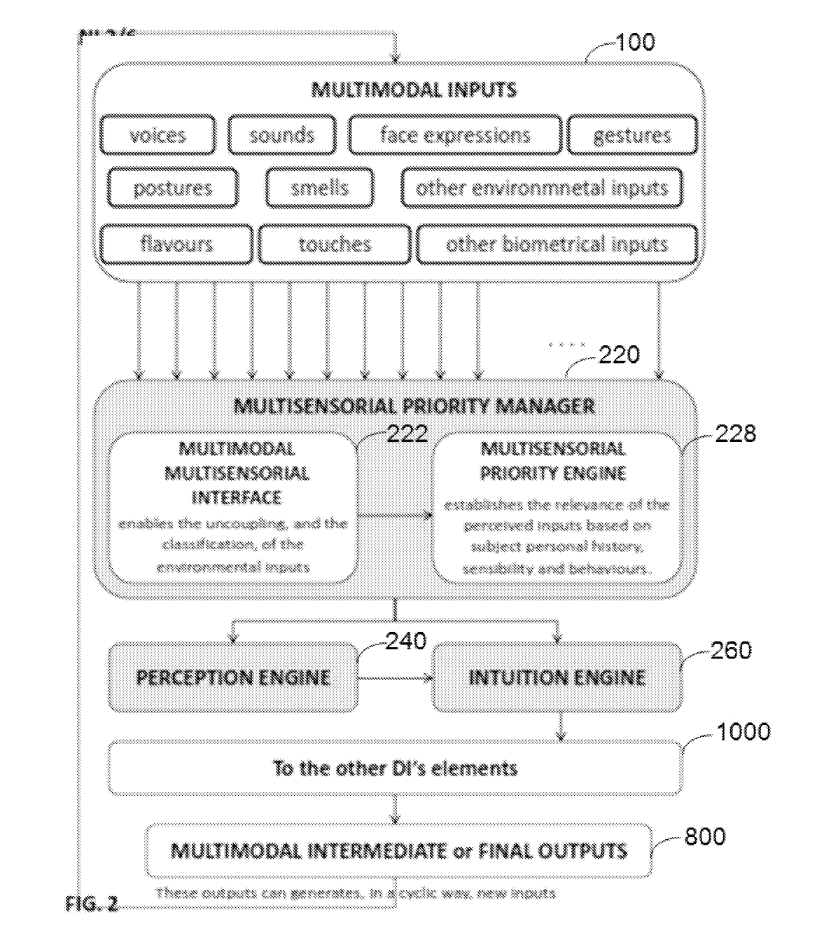

The interaction with the environment and the way it could influence the DI is shown in FIG. 2. First, Multimodal Inputs 100 are received, including voices, sounds, face expressions, gestures, postures, smells, other environmental inputs, flavours, touches, and other biometrical inputs. The Multimodal Inputs 100 are then received by the Multisensorial Priority Manager 220, which comprises the Multimodal Multisensorial Interface 222 and the Multisensorial Priority Engine 228. The Multimodal Multisensorial Interface 222 enables the uncoupling and the classification of the environmental inputs, while the Multisensorial Priority Engine 228 establishes the relevant of the perceived inputs based on subject personal history, sensibility and behaviors. After being processed by the Multisensorial Priority Manager 220, the Multimodal Inputs 100 are received by both the Perception Engine 240 and Intuition Engine 260. The Perception Engine 240 also sends input to the Intuition Engine 160. The Intuition Engine 260 then sends the processed Multimodal Inputs to the other DI elements 1000, which subsequently sends them to the Multimodal Intermediate or Final Outputs 800. These outputs can generate, in a cyclic way, new inputs, thus repeating the process.

As shown in FIG. 2, for this computation, Circum 200 mainly uses data managed by the Multisensorial Priority Manager 220 and the algorithms of the Perception Engine 240 and Intuition Engine 260.

The Multisensorial Priority Manager 220 contains a Multimodal/Multisensorial Interface 222 and a Multisensorial Priority Engine 228 which is able to assign different priorities to perceived inputs.

The Multimodal/Multi-sensorial Interface 222 enables the uncoupling of the environmental inputs perceived through the sensors (actuators) and their perceptive valence thus allowing the senses (e.g.: smell) and the reactions they trigger in a Digital Identity to be kept distinct from their technological actuators. The Multimodal/Multi-sensorial Interface 222 categorizes the stimuli as:
explicit stimuli: language stimuli consciously generated by the interlocutors;
non-explicit stimuli: language stimuli unconsciously generated by the interlocutors;
evocative stimuli: the non-language stimuli unconsciously generated by the interlocutors or by the environment;
Social stimuli are the stimuli derived by the level of intimacy of the interlocutors.

The Multisensorial Priority Engine 228 establishes the relevance of the perceived inputs. Decisions about relevance can be based on subject personal history, sensibility, memories and behaviors. Subject personal history, sensibility, memories and behaviors are stored and catalogued by the other logical elements of the platform.

An Example of the Multisensorial Priority Manager's activity is as follows:

1) The DI platform, through the multimodal/multi-sensorial interface, receives and recognizes different simultaneous stimuli as inputs, for example:
Three people are in the room, and one of them is recognized as a good friend, and the other two are unknown;
The friend tells the DI: “Hi, I want to introduce you to my colleagues,” but
The DI recognizes a nervous behavior based on fear;
The DI recognizes that all the unknown persons have a perplexed behavior;
One of the unknown persons emanates a recognized smell;

2) The DI platform categorizes these stimuli as:
Three people in the room: as social stimulus;
The friend talking to the DI: as explicit language stimulus;
The DI recognizing a nervous behavior based on fear: as non-explicit language stimulus;
The DI recognizing that all the unknown persons have a perplexed behavior: as non-explicit language stimulus;
One of the unknown persons emanates a recognized smell: as evocative stimulus;

3) The DI platform, through the Multisensorial Priority Engine 228, assigns a weight of each single input based on the subject's personal history, sensibility, memories and behaviors. These weights can range for example from 0-100% and any number falling within this range. In the Example:
35% to the presence of unknown persons in the DI's environment. This is because the represented subject takes care of the differences between his public appearances versus his private appearances;
30% to the good friend's fear. This is because the represented subject has a good rapport with his friend;
20% to the meaning of the good friend's speech. This is because the represented subject gives more weight to non-verbal communication compared to verbal communication;
10% to the behavior of the unknown persons. This because the represented subject also observes the environment in addition to the interlocutor;
5% to the smell of the unknown person. This is because the represented subject thinks that the appearance and smell of each person (as in outfit, perfume, accessories, etc.) represent the person as he/she is.

4) The received stimuli and the results of the Multisensorial Priority Manager 220 are transmitted to the Perception Engine 240 and Intuition Engine 260.

The other two modules that compose the Circum 200 are the Perception Engine 240 and the Intuition Engine 260.

The Perception Engine 240 represents the capacity of the DI to understand the non-explicit stimuli coming from the environment and includes these with the explicit stimuli, in order to obtain the best perception on the events that occur around the DI. To optimize the perceived environment, the Perception Engine 240 uses the weight generated by the Multisensorial Priority Engine 228 and transforms the non-explicit stimuli into explicit stimuli. The words (or tags or symbols) used to describe the non-explicit stimuli are dependent on the weight assigned.

The following is an Example of the Perception Engine's activity:

Using the above example the Perception Engine 240 receives from the Multisensorial Priority Manager 220 the five simultaneous inputs with the weights added and considers the two non-explicit stimuli based on body language:
A nervous behavior of the friend, based on fear;
A perplexed behavior of the unknown persons.

The Perception Engine transforms these two non-verbal messages into verbal messages that enrich the original verbal message coming from the Multisensorial Priority Manager 240.

In the Example the verbal message: “Hi, I want introduce my colleagues to you” becomes:

“This is George, my friend”+“I am in your environment”+“I want to introduce my colleagues”+“Be careful of what you say. These aren't my friends and they can generate problems for me at work.”+“They are my friend's colleagues and they are hesitant, but not with a negative impression, about DI.”

The words used to describe the non-explicit stimuli are dependent on the weight assigned to the stimuli by the Multisensorial Priority Engine 228.

The Intuition Engine 260 represents the capacity of the DI to generate new stimuli based on the original ones plus the relevance introduced by the Multisensorial Priority Engine 228 and the redefinition computed by the Perception Engine. To construct an intuition, the engine uses an opposite classification of the subject's memories, where each item is connected with the others by fuzzy logic. In embodiments, fuzzy, fuzzy values, or fuzzy logic in the context of this specification can mean that possible answers are aggregated into a dimensional spectrum instead of absolute true/false designations as in classical logic. In contrast, fuzzy logic includes 0 and 1 as extreme cases of truth as well as various intermediate states of truth. For example, where an answer calls for identifying whether the environment is cold or hot, the answer may be expressed as a degree of coldness (0.45) or a degree of hotness (0.55). This type of logic is similar to how human brains operate, where data is aggregated to form partial truths, which partial truths are then aggregated into higher truths, which higher truths can then cause certain motor responses (such as removing a hand from a hot stove) when a particular threshold is exceeded. The intuition born from the application of artificial intelligence methods (i.e. by methods based on neural networks) applies to the data and inputs.

In the intuition's process an analysis of facial similarity is applied. The face of each unknown interlocutor will be compared, by biometrical methods, to the faces inserted in the knowledge of the DI. If the similarity passes a threshold value, the emotional attributes of the stored faces, in the DI's knowledge, will be used to compute the intuition.

The intuition will be detected by the interlocutors as an answer (verbal or/and non-verbal) to the previous stimuli.

This process will be reiterated in order to collect new stimuli for the DI. These stimuli are re-analyzed by means of the Multisensorial Priority Engine 228 and the Perception Engine 240. The results, inserted in the Intuition Engine 260, contribute to validate or discard the intuition.

The cycles of reiteration are structured in a way to obtain a reinforcement learning where, at the end, the intuition is adopted or discarded.

The following is an Example of the Intuition Engine's activity:

1) Using the above Example the Intuition Engine receives from the Multisensorial Priority Manager the five simultaneous inputs with the weights added and considers the evocative stimuli (one in the Example above):
One of the unknown persons emanates a recognized smell.

2) Based on the information stored in the subject's memories, the Intuition Engine collects a set of values related to the stimulus (e.g. a type of cologne). These fuzzy values represent the persistence of connection of this stimulus with the other items of the subject's memories and his ethical and emotional assertions. In the Example, this type of cologne is strongly associated with the ethical values of honesty and rightness. This is because in the subject's memories this perfume is associated with his grandfather and he is associated with the values of honesty and righteousness.

3) The Intuition Engine generates a new explicit stimulus to add to the previous ones. The new stimuli's collection becomes “This is George, my friend”+“I am in your environment”+“I want to introduce my colleagues to you”+“Be careful of what you say-these aren't my friends and they can generate problems for me at work.”+“They are my friend's colleagues and they are hesitant, but not with a negative impression, about DI”+“My intuition detects that probably one of these colleagues is an honest and righteous man.”

4) These are the Circum's output transmitted to the other elements of the DI platform. These outputs allow it to generate an intermediate answer able to enforce, weaken or solve the DI's intuition.

5) If the DI's intuition is not solved the process 1-4 are repeated.

6) If the DI's intuition is solved the fuzzy values that represent the persistence of connection of this stimulus with the specific items of the subject's memories and his ethical and emotional assertions, are upgraded.

In summary, the Circum describes a cognitive matrix that stimulates the DI's perceptual system, acquiring the different input stimuli and transmitting them, repeatedly, to the other elements of DI's platform in order to obtain a decision about the right answers to deliver.

Second element of Digital Identity: Societas 300

In order to allow the Digital Identity an exhaustive understanding of external environments the present inventors introduce Societas 300: a specific logic element tied to each subject's identity and relationships.

Societas 300 gives/limits access to each specific piece of information. Stored information (memories, biography, etc.) are not accessible to all interlocutors, but information access is filtered on relationships values such as relatives, friends, groups and interests.

For example, the same question asked by two different interlocutors may therefore generate responses that are different in content, emotional reaction, prosody, gestures, etc.

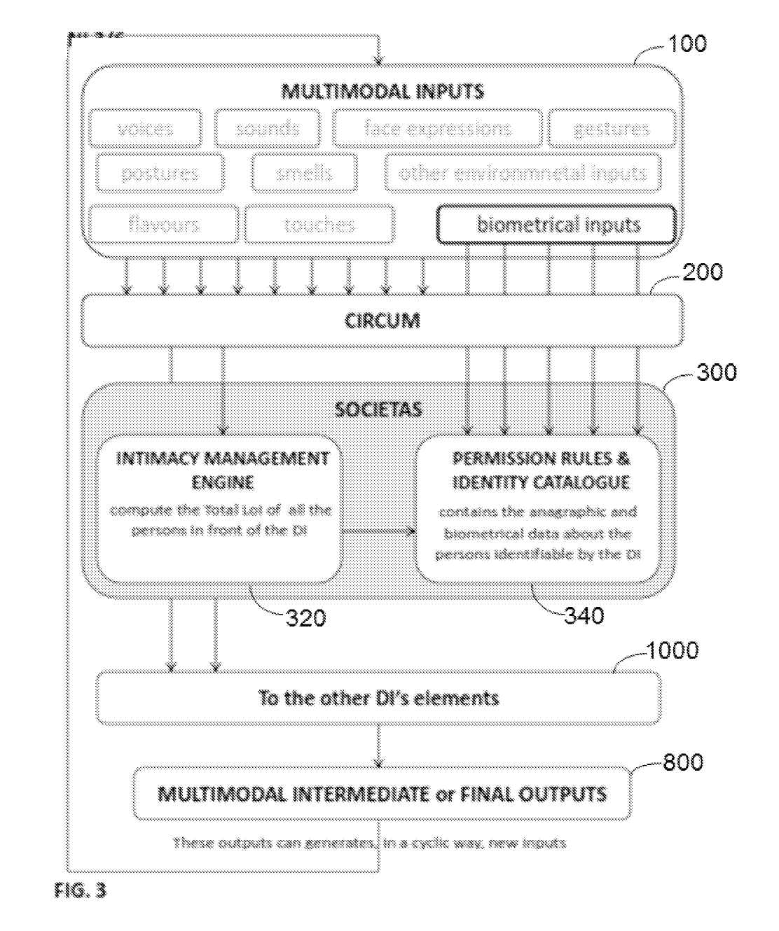

The interaction between Societas 300 with the environment and the way it influences the DI's answers is shown in FIG. 3. First, the Multimodal Inputs 100 described previously are received by the Circum 200, except for the biometrical inputs which are received by the Permission Rules and Identity Catalogue 340. Further, the Intimacy Management Engine 320 receives input from the Circum 200, which sends an output to the Permission Rules and Identity Catalogue 340. The output of the Intimacy Management Engine 320 is the total Level of Intimacy of all the persons in front of the DI. The Permission Rules and Identity Catalogue 340 contains the anagraphic and biometrical data about the persons identifiably by the DI. The total Level of Intimacy is outputted from Societas 300 to the other DI's elements 1000, which sends an output to the Multimodal Intermediate or Final Outputs 800. These outputs then can generate, in a cyclic way, new inputs, thus repeating the process.

As shown in FIG. 3, Societas 300 is composed of two modules:

a) The Permission Rules and Identity Catalogue 320 and

b) The Intimacy Management Engine 340.

The Permission Rules and Identity Catalogue 320 contains the personal and biometrical data of the persons identifiable by the DI. Each person is connected to a set of attributes that identify him/her, his/her intimacy status with the DI and his/her social group.

The intimacy status is an integer that identifies the Level of Intimacy (LoI) between an interlocutor and the DI. The LoI is coupled with the number of occurrences that identify the number of relations occurring between the interlocutor and the DI.

The social groups are characterized by: their social values (e.g.: gender, range of age, race, ethnicity, citizenship, religion, social class, level of study, kind of work, etc.), their emotional appeal, and their ethical and moral values.

The social values can be segmented in a more refined way (e.g.: citizenship=“citizen of New York” instead of “citizen of USA”).

The emotional appeal will be catalogued in accordance with the Indoles's emotional parameters (see the Indoles description below) and, for the known person, are collected in the Memories Repository (see the Animus description below).

The ethical and moral values will be catalogued in accordance with the Ethical and Moral Module parameters (see the Ethical and Moral Module description below).

Following the previous Example, the three persons in the room, at the beginning, are catalogued as:

George (identified by DI by the face detection system):
Intimacy status: 1.0 (max intimacy=0; min intimacy=9).
Occurrence score: 132.
Social values: male, 60-75, Caucasian, Scandinavian, US citizen, protestant, middle class, graduate, engineer.
Emotional appeal: vigilance (8)+trust (40)+serenity (22).
moral & ethical values: protestant (high)
unknown person 1 (identified by the face detection system and by means of George's verbal phrase)
Intimacy status: 7.0 (good friend's colleague).
Occurrence score: null.
Social score: male, 40-50, Caucasian, null, null, null, null, null, null.
emotional appeal: vigilance (−6)
moral & ethical values: null
unknown person 2 (identified by the face detection system and by means of George's verbal phrase)
Intimacy status: 7.0 (good friend's colleague).
Occurrence score: null.
Social values: female, 40-50, Asian, null, null, null, null, null, null.
emotional appeal: vigilance (−6)
moral & ethical values: null

The Intimacy Management Engine 320 computes the Total Level of Intimacy (Total LoI) of the “set of interlocutors”: all the single individuals in front of the DI (equal: in relation with the DI at the same time). The Total LoI will be used by the other modules to define the quality of the answer (in terms of content and verbal and non-verbal expressions) released to the set of interlocutors.

Total LoI=SUMMATIONᵢ [LoI(i)*vigilance(i)]/number of interlocutors;

LoI (i)=LoI of interlocutor=function (intimacy status, social values, emotional appeal, moral and ethical values);

vigilance₍ᵢ₎=f(network connection₍ᵢ₎)=Is a function that represents the weight of vigilance that the DI uses to deliver an answer. The DI computes this weight starting from the quality of connections between the interlocutor(i) and the known network of persons.

This approach allows the DI to set the LoI based on personal parameters of the interlocutor, and the influence of the interlocutor on the social network connected with DI.

The Intimacy Management Engine 320 computes in a recursive way the Total LoI, based on the stimuli received. It starts with a Total LoI (t₀) and it modifies this value based on new information accumulated during the session of dialogue between the interlocutors and the DI. The LoI of each interlocutor will be upgraded in a different way:

1. If an interlocutor is unknown, the information collected during the dialogue can modify the parameters of social group;

2. If an interlocutor is unknown, but the DI collects enough data to identify him/her in a unique way (typically biometrical data) then the intimacy status is upgraded;

3. If the interlocutor is known or unknown, but a known interlocutor with enough intimacy status endorses him/her, he/she can obtain an intimacy status upgrade;

4. If the interlocutor is known, the information collected during the dialogue can modify the parameters of social group and, eventually, the intimacy status will be upgraded;

5. If the interlocutor is known but his/her number of occurrences exceeds a defined threshold, eventually, the intimacy status will be upgraded.

The DI's subject defines all the weight, threshold and other elements used to determine a temporary or lasting variation of LoI.

In the Example, the three persons in the room, at the beginning, are catalogued as shown above. The other information arrived from the Circum are:

“This is George, my friend”+“I am in my environment”+“I want to introduce you to my colleagues”+“Be careful of what you say. These aren't my friends and they can generate problems for me at work”+“They are my friend's colleagues and they are hesitant, but not with a negative impression, about DI”+“My intuition detects that probably one of these colleagues is an honest and righteous man”.

This information will modify the following social values:
unknown person 1 (identified by the face detection system and by means of George's verbal phrase and by a smell detector)
emotional appeal: vigilance (−6) vigilance (−8)+trust (6)
unknown person 2 (identified by the face detection system and by means of George's verbal phrase)
emotional appeal: vigilance (−6) vigilance (−8)

The outputs of Circum 200 and Societas 300 are sent to other modules that will decide the opportune answer. To continue the Example, let us suppose that the DI's answer will be “Hi, George. I am glad to see you again. Would you introduce your colleagues to me?”

George says: “Ok! Barry is the new director, he is an engineer and he arrived in the company only two months ago. He is full of energy and new ideas. Daphne works in the Engineering Department also. She is a longtime colleague and good friend. They are really excited to meet you and speak with you.”

This new verbal information (connected with the related non-verbal information), will modify the social, emotional and ethical values in this way:
unknown person 1=Barry
Intimacy status: 7.0 (good friend's colleague).
Occurrence score: null.
Social values: male, 40-50, Caucasian, null, null, null, null, graduate, engineer.
emotional appeal: vigilance (−8)+trust (6)
moral & ethical values: null
unknown person 2=Daphne
Intimacy status: 7.0 (good friend's colleague).
Occurrence score: null.
Social values: female, 40-50, Asian, null, null, null, null, graduate, engineer.
emotional appeal: vigilance (−8)=vigilance (−1)+trust (12)
moral & ethical values: null

The modification of some parameters for “unknown person 1” and “unknown person 2” augments the Total LoI sent to other modules that will compute the opportune answer (more “friendly” than the previous one) . . . and so on.

After some interactions between the DI and the group of interlocutors, the Total LoI is probably stable and, consequently, the quality of relation too.

If the biometrical sensors have collected enough data to recognize Barry and Daphne, they modify their intimacy status with the DI.
unknown person 1=Barry
intimacy status: 7.0 (good friend's colleague)→6.0 (acquaintance)
occurrence score: 1.
Etc.
unknown person 2=Daphne
intimacy status: 7.0 (good friend's colleague) 6.0 (acquaintance)
occurrence: 1.
Etc.

Third element of Digital Identity: Indoles 400

The third logical element is the Indoles 400. Each DI has a specific emotional and psychological model that can be constructed from those available in the literature or tailored specifically to the user one is representing. The Indoles 400 contain the n-dimensional map of the emotional states and the psychological model that defines the transition rules from an emotional status to another. The Indoles Module 400 includes the parameters to set the correct facial expressions and positions of body and hands for a 2D/3D representation, and affects voice synthesis.

Each dialogue is mapped as an n-dimensional point into the map of emotions calculated by means of the emotional tag of a specific memory state received as an input from the Animus.

While Indoles 400 (and Animus 500) receive stimuli from Circum 200 and Societas 300, related outputs are calculated and passed to the Loquor 600 and Corpus 700 modules for the right representation.

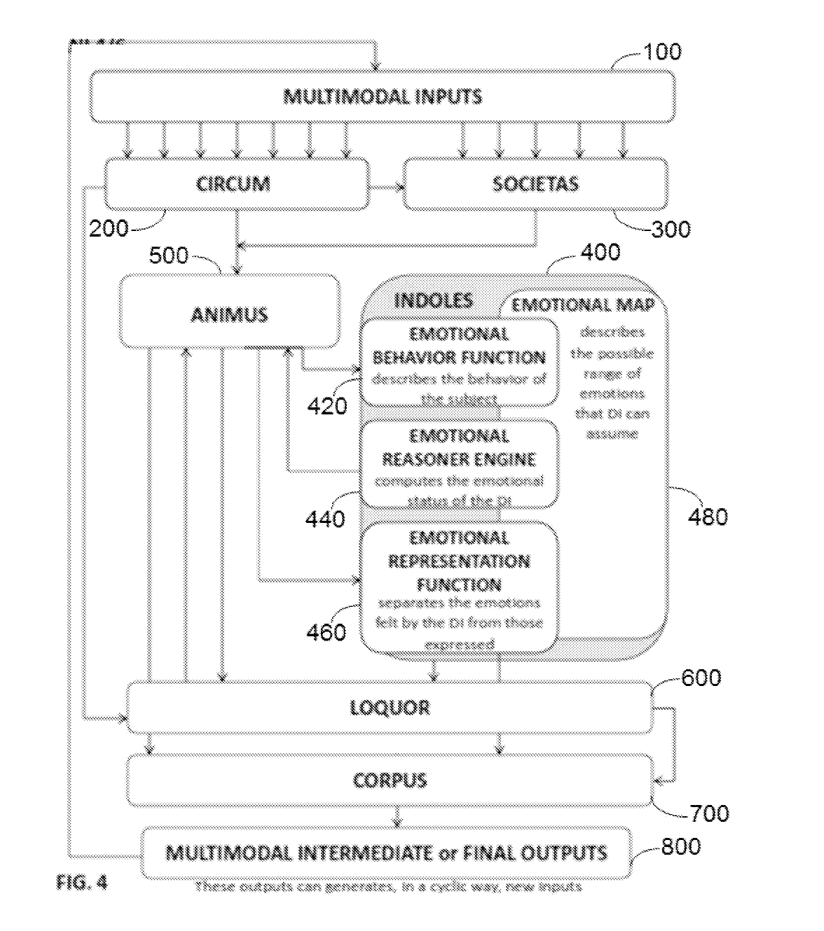

FIG. 4 shows interactions between Indoles and the other logical elements of DI.

FIG. 4 shows that Indoles 400 is composed of four modules:

a) the Emotional Behavior Function 420;

b) the Emotional Reasoning Engine 440;

c) the Emotional Representation Function 460; and

d) the Emotional Map 480;

The Animus 500 sends inputs to the Emotional Behavior Function 420 and Emotional Representation Function 460, while receiving input from the Emotional Reasoner Engine 440. Further, the Indoles sends a general output to the Loquor 600 and a specific output to the Corpus 700 through the Emotional Representation Function 460. The Corpus 700 sends an output to the Multimodal Intermediate or Final Outputs 800, which may then generate further inputs.

The Emotional Map 480 describes the possible range of emotions that DI can assume. This map is unique for all the DIs created, and represents the state of the art of the study on human emotion. The map uses an n-dimensional representation of the Plutchik's Wheel.

The Emotional Behavior Function 420 describes the behavior of the subject into the Emotional Map 480, tracing the possible paths that our subject can follow into the map. For example, if our subject has an emotional block in his/her personal level of Joy, her/his possible paths can never reach the maximum level of joy allowed into the map (i.e. maximum level of Joy=50, while the user's stops at level 30).

The function of emotional behavior is set during the DI configuration phase, when the psychologists analyze the subject's behavior through an interview, posture analysis and public and private behavior, etc.

The Emotional Reasoning Engine 440 computes the emotional status of the DI, with these main steps:

a) detection of the actual position in the Emotional Map 480;

b) reception of the input's stimuli, fitted and elaborated by Circum 200 and Societas 300;

c) extraction by the Memories Repository (see below in the Animus element) the emotional values related at the ongoing dialogue;

d) computation of the next position in the Emotional Map 480 function of: actual position, emotional values received from Circum 200, emotional values received from Societas 300, emotional values extracted from Memory Repository.

In absence of any kind of stimuli, the engine computes a new position on the emotional map for each time fraction. This computation is based on a function of the emotional drift set established during the configuration phase of the DI. That is, the new position on the emotional map is a position on one of the possible paths outlined in the emotional map for this particular DI. This concept is explained in more detail in the following example.

Going back to the previous Example: at the beginning of the conversation, before the DI discovered the interlocutors, it had the following emotional state. The Plutchick Wheel will be represented by a four-dimensional axis, each with boundaries [−40, +40]:
joy/sadness axis [0], that represents a neutral condition with respect to this axis;
trust/distrust axis [0], that represents a neutral condition with respect to this axis;
fear/anger axis [0], that represents a neutral condition with respect to this axis;
surprise/anticipation axis [0], that represents a neutral condition with respect to this axis.

After a lapse of time the Emotional Reasoning Engine 440 modifies the original emotional status (i.e. a situation of boredom with a little annoyance):
joy/sadness axis [0];
trust/distrust axis [−22];
fear/anger axis [−21];
surprise/anticipation axis [0].

When the interlocutors are discovered, the emotional state becomes a situation of anticipation mixed with a little apprehension for the new visitors:
joy/sadness axis [0];
trust/distrust axis [0];
fear/anger axis [22];
surprise/anticipation axis [−15].

After the elaboration of the first round of stimuli through Circum 200 and Societas 300, the emotional state elaborated by the Emotional Reasoning Engine 440 becomes:
joy/sadness axis [22];
trust/distrust axis [+18];
fear/anger axis [30];
surprise/anticipation axis [−5].

This emotional status: “elevated vigilance, generated by George's verbal and non-verbal messages, combined with a serenity and trust, due to the presence of a good friend, and a little apprehension due to the subject's personality” is used to compute, according to the Animus, the next answer . . . and so on.

The purpose of the Emotional Representation Function 460 is to separate the emotions felt by the DI from those expressed. In the process of the present invention the stimuli are sent simultaneously to the Indoles modules and to Moral & Ethical modules (see Animus described below). The outputs of the modules will be sent to the Decisional Engine (see again Animus) to decide the DI's correct status (and consequently the answers and outputs) for the received stimuli. The DI's status contains the correction parameters of emotional behavior. These parameters are used to compute the emotional representation showed by DI, in other words the function computes the new point in the Emotional Map.

The Emotional Representation Function 460 defines the boundaries, in the Emotional Map 480, of the emotions that the DI is able to show.

Similarly to the Emotional Behavior Function 420, this function is set by psychologists during the DI configuration phase.

During the computation of the next answer, the Decisional Engine of the Animus 500, sends the emotional values connected to the answer to the Emotional Representation Function 460. For simplicity, let us suppose that these values aren't changed with respect to those presented above.

The Emotional Representation Function 460 modifies these values in a way to show the external emotional behavior of the subject. In the Example, if the subject is a personality classified as “I won't” (typically a soldier or other person who is expected to express little emotion in response to stimuli), his/her emotional values become:
joy/sadness axis [22];
trust/distrust axis [+18];
fear/anger axis [−25];
surprise/anticipation axis [−5].

This external emotional status becomes: “elevated vigilance, combined with serenity and trust, and a little unfriendliness, due to the subject's personality”.

In this way the DI can use the emotional status, computed by the Emotional Reasoning Engine 440, to influence the Animus's decision about the answers. The new emotional status, computed by the Emotional Representation Function 460, defines the external appearance of the DI.

Fourth element of Digital Identity: Animus 500

The Digital Identity core is the Animus 500: it is the representation of the subject's memories, of its capacity to compute a decision based on the data known, and his/her ethical and moral values. The Animus 500 is structured around a storage and computing system in which the subject's memories are related to the subject's emotions, his/her sensations, his/her prosodic, lexical, moral, religious and psychological characteristics and other personal attributes connected with the memories.

The Animus 500, together with Indoles 400, receives data from Circum and Societas. They process these inputs and pass the results to the Loquor and Corpus for the right representation of the answers.

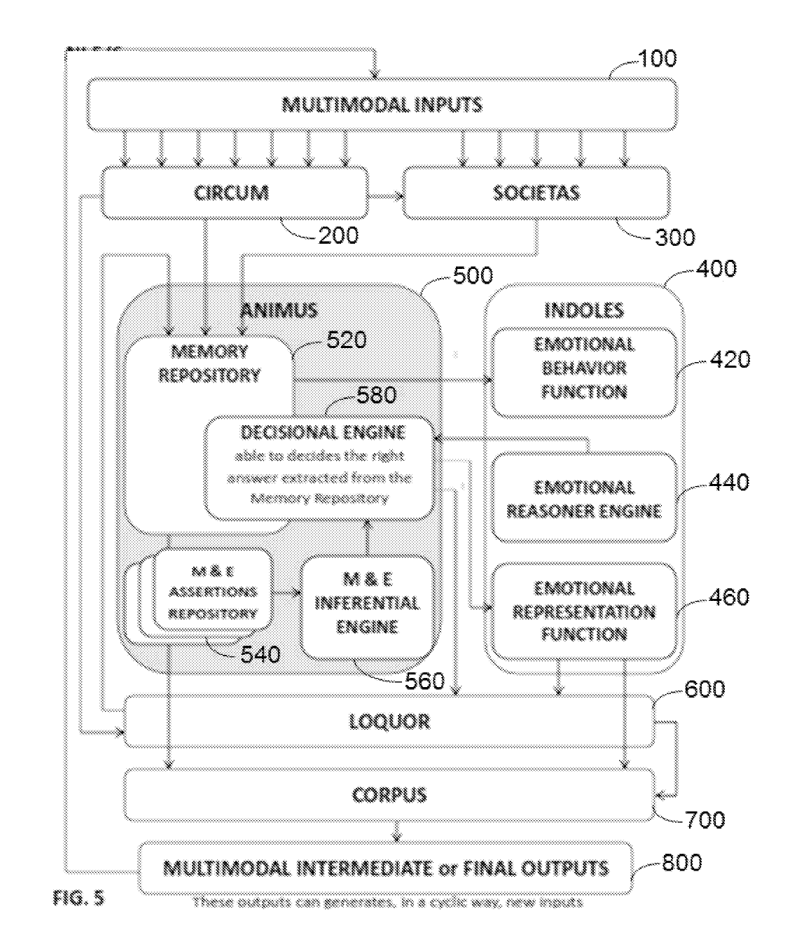

Relationships between Animus 500 and other elements are described in FIG. 5. The following represents a high level overview of the Animus 500 shown in FIG. 5. In brief, the Animus 500 comprises four components: the Memory Repository 520, the M&E Assertions Repository 540, the M&E Inferential Engine 560, and the Decisional Engine 580. The Memory Repository 520 receives inputs from the Circum 200, Societas 300, and Loquor 600. The Memory Repository 520 sends an output to the M&E Assertions Repository 540, which sends an output to the M&E Inferential Engine 560, which sends an output to the Decisional Engine 580. Further, the components of the Animus 500 interact with the components of the Indoles 400. The Memory Repository 520 sends an output to the Emotional Behavior Function 420 of the Indoles 400. The Decisional Engine 580 receives an input from the Emotional Reason Engine 440 of the Indoles 400 and sends an output to the Emotional Representation Function 460. The Animus 500 also sends an output to the Loquor 600 through the Decisional Engine 580 and sends an output to the Corpus 700 through the M&E Assertions Repository 540. The Corpus 700 sends an output to the Multimodal Intermediate or Final Outputs 800 which may generate new inputs.

The memories are perpetuated and stored in the Memory Repository 520, a highly structured organic framework based on multiple levels of information.

i. The first set of components regards the subject's personal biography: a catalogue of the person's memories. The information contained includes all the data necessary to contextualize the memory: timestamp of memory insertion, localization, timeframe of memories (age of the subject), taxonomic classification of the memory, connection with other memories and references to the different topics, etc.

ii. Each biographical memory may have a different form. The memories of the subject may be structures in the form of the subject's sentences (texts), subject's narration of an experience (texts), external document, videos, images, verbal audios and music, etc.

iii. Each memory also contains other resources such as specific smells or other sensorial stimuli such as sounds, taste and flavor descriptions, tactile descriptions, etc. . . . connected with the Circum 200 element.

iv. Each memory includes the identified people involved in the memory and its affiliation, at a relation level, to a specific socio/demographic group. This information, joined with Societas's data, allows the right level of disclosure of the memory to be set.

v. The last set of Memory Repository 520 contains the emotional, ethical and moral values and tags which are used, based on predetermined models, to compute the emotional and moral reaction applicable to each specific memory.

In order to protect the private data of the subjects, the Memory Repository 520 preserves the memories using encryption techniques with public or private keys.

The memories are catalogued by means of different ontologies related to the subject. The search (and extraction) of the memories related to an input stimulus is developed using the subjective semantic analysis of the input stimulus (see Loquor 600 described below).

The Animus 500 also includes the following different computational modules:

i. A Moral and Ethical Module that holds the ethical and religious rules fitted to our subject.

ii. A Decisional Engine 580 to compute the right answer based on:

a. the input's stimuli manipulated from Circum 200 and Societas 300,

b. data from the Moral and Ethical Module,

c. the emotional values computed by the Emotional Reasoning Engine 440 (see Indoles above described),

d. the subject's memories and biography.

This approach enables the generation of a specific response adapted to a determined situation, question and/or stimuli even if they are already known and classified in the Animus 500, or never encountered before (not classified in the Animus 500 memories or biography).

The Moral and Ethical Module (M&E Module) is composed of two main components: the M&E Assertions Repository 540 and M&E Inferential Engine 560.

The M&E Assertions Repository 540 is a database of sentences that define the positive or negative value of an action or a thought. The set is divided in subsets, each of these representing a collection of sentences unified by a moral (e.g.: the Four Gospels, the Holy Bible, the Critique of Pure Reason, the Constitution of the United States, the Way of Bushido, the Vegan Style of Life, etc. . . . ). Each subject can have more than one moral (including sentences in contrast) and especially preferred are such morals emanating from one or more sources.

Modification of the standard morals or creation of new morals will be applied during the memories data collection phase.

The database is indexed in a way to simplify the research of sentences.

When a memory is stimulated by the inputs, the M&E Inferential Engine 560 searches for sentences that can be provided as possible responses/answers/arguments in the database of the M&E Repository 520. The responses/answers/arguments are identified by the tags or by the values stored in the M&E Repository 520 and connected with the specific memory. The M&E Inferential Engine 560 applies a sentiment analysis on the sentences to evaluate the positive or negative relevance of the stimulus and of the related memories.

The results of this analysis may increase or decrease the moral and ethical relevance of the stimulus.

Always using as a guide the Example mentioned above, the input stimuli generated from Circum 200 and Societas 300 are, Barry says: “Nice to meet you, I'm very excited to speak with you. You are very realistic and I'm curious to better understand your performance. In the past I was interested in the cryogenic process but it did not convince me.”

These stimuli activate in the Memory Repository 520 the memories related to the concepts:

PREVIOUS: “Barry”, “new colleague”, “engineer”, “full of energy”, “new ideas”, “he is excited to meet me”, “He wants to speak with you”, and other keywords semantic-equivalent.

ACTUAL: “curious”, “immortality”, “cryogenic process did not convince him”, and other keywords semantic-equivalent

From the Memory Repository the memory extracted will be, in a simplified example:

“I like curious minds but not curious persons”, “I feel tentative to obtain immortality of my memories, of my moral values and transmit my experiences to others”, and “A cryogenic process is a way to find immortality. The process consists of hibernating the body . . . ”, etc.

As moral and ethical attributes of the memories, the only one indexed is the Holy Bible with a high level of relevance for the subject. By means of the sentiment analysis, we can find in the Holy Bible:
different sentences with negative values about the “immortality of the body”
different sentences with negative values about the “research of immortality for humans”
different sentences with high positive values about the “research of immortality for the soul”
different sentences with little positive values about the “preservation of the memories”
etc.

These data about the actual stimulus, together with other stimuli and related information, are transmitted to Decisional Engine.

The Decisional Engine 580 is an A.I. engine able to decide the right answer, selected between the memories extracted from the Memory Repository 520, and based on the criteria arrived from Circum 200, Societas 300, Indoles 400 and M&E Engine 580. To follow the main steps of the process to select the best answer:

i. From Loquor 600, the verbal stimuli (phrases) filtered by means of the subjective NLP (see Loquor element below described);

ii. From Circum 200, the non-verbal stimuli (translated in textual descriptions);

iii. From Intuition Engine 260 the memories recalled by the intuition (these memories have a different relevance);

iv. Using the semantic analysis, on texts, tags and descriptions, the Decisional Engine finds, and extracts, all the memories that satisfy the received stimuli;

v. The Decisional Engine 580 starts the computation to identify the best answer based on the selected memories. For the computation the Decisional Engine 580 compares the output of other modules with the attributes of each selected memory:

a. The Total LoI (output of Societas 300) establishes which among the selected memories are compatible with the interlocutors;

b. The outputs of Indoles that permit it to obtain the emotional status of the DI related to the present stimuli and the emotional status of the DI related to each memory adopted as a possible answer;

c. The outputs of the M&E Engine 580 that permit it to recognize the moral and ethical values related to the received stimuli;

d. A dedicated algorithm compares the relevance of the emotional impact of the stimuli and the related memories, with the relevance of their own moral impact. This algorithm is set by psychologists during the analysis of the subject's personality phase of the DI configuration;

e. The algorithm's result can modify the Total LoI value. In this case the steps b will be repeated and if we obtain a new set of selected memories, the steps c. and d. will be repeated up to obtain a stable result.

Fifth element of Digital Identity: Loquor 600

The fifth element is Loquor 600: representing the dialogical capacities of Digital Identity.

This capacity is divided into two main branches: one devoted to understand the verbal and non-verbal languages of the interlocutors and the other one to express, by means of verbal and non-verbal languages, the answers and reactions to the input stimuli.

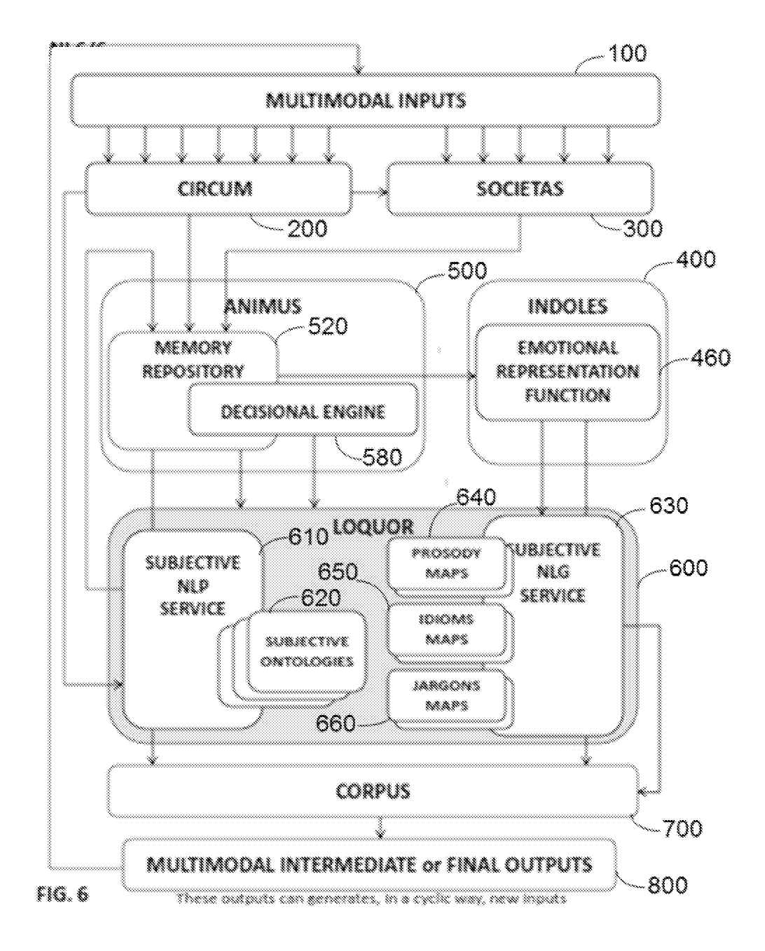

The interaction between Loquor 600 with the other logical elements of DI is shown in FIG. 6. The following represents a high level overview of FIG. 6. First, the Loquor 600 receives general input from the Memory Repository 520 and Decisional Engine 580 of the Animus 500. Second, the Loquor 600 contains both the Subjective NLP Service 610 and the Subjective NLG Service 630. The Subjective NLP Service 610 is associated with Subjective Ontologies 620, while the Subjective NLG Service 630 is associate with Prosody Maps 640, Idioms Maps 650, and Jargons Maps 660. Further, the Subjective NLG Service 630 receives specific inputs from the Emotional Representation Function 460 and sends an input to the Corpus 700. The Subjective NLP Service 610 receives an input from the Circum 200 and sends an output to the Memory Repository 520 of the Animus 500 and the Corpus 700. Further, outputs from the Memory Repository 520 and Emotional Representation Function 460 pass through the Loquor 600 to the Corpus 700.

The first Loquor's branch is Subjective NLP Service and Ontologies 610. It's devoted to the identification of meaning of an input's stimuli, not only based on generic language ontologies and a NLP (Natural Language Processing) system but also capable of creating a connection with the individual's ontologies of the Digital Identity. In fact the state of the art technology is based on understanding a concept with the goal of identifying one or more answers based on the following process: a) the system receives and interprets (voice or text) input by means of an NLP service and uses the related ontologies in order to deduce the “common meaning” of the phrases and b) using results acquired in the previous step, solves the input by means of searching and extracting the contents from the knowledge base.

Loquor 600 provides a new approach to understanding, where the system:

a) receives the input (verbal or text) and, by means of a subjective NLP and subjective ontologies, understands the “common meaning” and the “intimate meaning” of the phrases (that can be very far from the “common meaning”) and

b) solves by means of searches and extractions of contents into the subject's memories.

Using this innovative approach, the system produces an answer consistent with the Digital Identity subject, and, overall, ensures that the question understanding process is tailored to the DI subject.

To solve point a), a multi-level catalogue of the different ontologies related to the subject is created: where the native language spoken by the subject (Language Ontology) is mandatory. In addition, other optional ontologies are created: one dedicated to the subject's individual expertise and environment (Cultural-Group Ontologies), those regarding social dialogue (Social Dialogue Ontology), and those created especially for a specific user (User Ontology). A subjective NLP service uses the previous ontologies to understand the “common meaning” and the “intimate meaning” of the verbal and non verbal messages.

Example of Subjective NLP and Subjective Ontologies:

Someone in the DI's family tells the DI: “Today its raining”. The Loquor assigns this sentence the meaning “Today the family is nervous”; this is because in the family's lexicon this is the right, and most common, interpretation of the assertion. Obviously, if the source of assertion belongs to a more external social circle, the interpretation of the Loquor will be aligned with the native language dictionary.

Other examples of Subjective NLP and Subjective Ontologies:

Someone says something about a raincoat. For our subject a raincoat is linked to a singer-songwriter (because the subject is a Leonard Cohen fan) and Paris (because only in Paris the subject had used a raincoat and, for him, many Parisians wear this kind of cloth).

The second Loquor branch is the Subjective NLG Service and the Related Library 630. They are devoted to express, by means of verbal and non verbal languages, the DI's answers and reactions and are connected with the NLG (Natural language Generation) service. The main components of this branch are the different types of libraries:

i. the library of phonemes for the Text-To-Speech customized on the subject;

ii. the library of the facial expression, customized on the subject.

Both the libraries can have some special add-ons including:

i. Prosody 640 is a matrix that transforms the emotions (received from the Emotional Representation Function) in a sequence of verbal and non-verbal elements selected from the libraries;

ii. Idioms 650 & Jargon Maps 660 are special sub-libraries that collect the typical expression of the subject. Similarly, to the NLP branch 610, Idioms 650 & Jargons Maps 660 are divided into five categories: universal, local, sectorial, relative and personal.

In this way, the DI can change the level of formality of the output language based on the DI behavior, the argument being made, and on the interlocutors. The default lexicon is more nested (personal) and according to the context level rises towards the broader level; it is therefore necessary that each element of the nested lexicon must have the semantic correspondence to the upper level. The NLG service 630 can decide when and how much information is lost in comparison to how much the receiver makes them understood by lowering the level of formality.

In example of applications:
the DI is a “teacher” with the goal of maximum understanding for the common interlocutors: the language will be, for the main part, the universal one;
the DI is a “teacher” with the goal of maximum understanding for the interlocutors with the same specialized skills: the language will be, for the main part, the sectorial one;
etc.

From this point of view idioms and jargons are different: the idioms are verbal translations that do not lose informational value but which approach or retreat to people of a certain social/cultural level (special categories of idioms are the proverbs and metaphors), while Jargon can produce a loss of information if used at the wrong social/cultural level.

Sixth element of Digital Identity: Corpus 700

The last element is the Corpus 700: it is the presentation layer of each Digital Identity that is a hyper-realistic representation of the subject. It is obtained through different advanced techniques capable of best representing both the physical characteristics (bone, muscle and the skin) and the voice (inflection, changes in tone, etc.) of the user.

The presentation layer can be static or can change in time. It can move (change emotion, voice inflection, posture and gesture) based on the indications it is given by the Animus and by the dialogical state.

The presentation layer communicates with the Animus 500 through a communication protocol that enables the decoupling of the presentation layer, based on the technology, from the decisional one tied to the Animus 500. This protects the entire system from technological obsolescence due to the adoption of audio/video presentation components destined to be surpassed.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. An artificial intelligence platform for representing a subject as a Digital Identity to one or more interlocutors through a dialogue, comprising one or more or all logical elements chosen from:
a Circum module operably configured for sensing information about an environment external to the Digital Identity;
a Societas module operably configured for identifying a level of intimacy between the subject and another individual;
an Indoles module operably configured for determining emotional and psychological behavior of the subject;
an Animus module operably configured for storing memories of the subject and for determining an answer to interlocutor inquiries;
a Loquor module operably configured for interpreting verbal and/or non-verbal languages of the interlocutors and expressing answers to the interlocutors using verbal and/or non-verbal languages; and/or
a Corpus module operably configured for determining physical and/or voice characteristics of the subject and representing the characteristics to the interlocutors.

2. The artificial intelligence platform of claim 1, wherein:
multimodal inputs are received by the Circum module, the Societas module, the Indoles module, and the Animus module;
the Circum module provides an output to the Societas module, the Indoles module, and the Animus module;
the Societas module provides an output to the Indoles module and the Animus module;
the Indoles module provides an output to the Animus module;
the Animus module provides an output to the Loquor module and to the Corpus module;
the Loquor module provides an output to the Corpus module; and
the Corpus module provides multimodal outputs.

3. The artificial intelligence platform of claim 1, wherein the Circum module (means for sensing) comprises a multisensorial priority manager, and perception engine, and an intuition engine.

4. The artificial intelligence platform of claim 2, wherein the multimodal inputs are processed by a multisensorial priority manager which thereby sends outputs to a perception engine and intuition engine.

5. The artificial intelligence platform of claim 4, wherein the multisensorial priority manager comprises a multimodal interface and a multisensorial priority engine.

6. The artificial intelligence platform of claim 5, wherein the multisensorial priority engine assigns a weight to multimodal inputs.

7. The artificial intelligence platform of claim 2, wherein the multimodal inputs are categorized by a multisensorial priority manager as explicit stimuli, non-explicit stimuli, evocative stimuli, or social stimuli and a perception engine uses a weight generated by a multisensorial priority engine and transforms non-explicit stimuli into explicit stimuli.

8. The artificial intelligence platform of claim 1, wherein the Societas module (means for providing a level of intimacy) manages access to stored information on the subject based on relationship values.

9. The artificial intelligence platform of claim 1, wherein the Societas module (means for providing a level of intimacy) comprises an identity catalogue of personal and biometric data about people identifiable by the platform, plus a permission rules and an intimacy management engine module.

10. The artificial intelligence platform of claim 1, wherein an intimacy management engine computes a total level of intimacy for the one or more interlocutors.

11. The artificial intelligence platform of claim 10, wherein a total level of intimacy is used by one or more logical elements to define an answer released to the one or more interlocutors.

12. The artificial intelligence platform of claim 1, wherein the level of intimacy is upgraded under the following conditions:
if the interlocutor is unknown, information collected during dialogue can modify parameters of a social group;
if the interlocutor is unknown, but the artificial intelligence platform collects sufficient data to identify him/her in a unique way;
if the interlocutor is known or unknown, but he/she is endorsed by a known interlocutor with sufficient intimacy status;
if the interlocutor is known, information collected during a dialogue with the interlocutor can modify parameters of a social group;
if the interlocutor is known but his/her number of occurrences exceeds a defined threshold.

13. The artificial intelligence platform of claim 1, wherein an emotional reasoning engine computes an emotional status of the artificial intelligence platform by:
detecting actual position in an emotional map;
receiving multimodal input's stimuli, fitted and elaborated by the Circum module (means for sensing) and the Societas module (means for providing a level of intimacy);
extracting by a memories repository of emotional values related at the ongoing dialogue; and
computing a next position in the emotional map function of actual position, emotional values received from the Circum module (means for sensing), emotional values received from the Societas module (means for producing a level of intimacy), and emotional values extracted from the memory repository.

14. The artificial intelligence platform of claim 1, wherein memories are stored in a memory repository.

15. The artificial intelligence platform of claim 14, wherein the memory repository and memories extraction are based on the following levels of information:
data necessary for contextualizing a memory comprising a timestamp of memory insertion, localization, age of the subject, taxonomic classification of the memory, connection with other memories and references to different topics;
a biographical memory comprising the subject's sentences, the subject's narration of an experience, external documents, videos, images, verbal audios and music;
sensorial stimuli comprising smells, sounds, taste, flavor descriptions and tactile descriptions;
identified people involved in a memory and their affiliation, at a relationship level, to specific socio/demographic groups; and
emotional, ethical and moral values and tags.

16. The artificial intelligence platform of claim 1, wherein the Animus module (means for storing memories and deciding an answer) comprises a moral and ethical inferential engine (including ethical and religious rules fitted on the subject) and a decisional engine.

17. The artificial intelligence platform of claim 1, wherein a decisional engine is configured to compute a correct answer to an interlocutor inquiry.

18. The artificial intelligence platform of claim 17, wherein the decisional engine is configured to compute a correct answer based on:
the multimodal inputs processed from the Circum module (means for sensing) and the Societas module (means for providing a level of intimacy);
data from the moral and ethical module;
emotional values computed by the emotional reasoning engine; and
the subject's memories and biography.

19. The artificial intelligence platform of claim 1, wherein a moral and ethical inferential engine applies a sentiment analysis on sentences to evaluate positive or negative relevance of multimodal inputs and related memories.

20. The artificial intelligence platform of claim 17, wherein the decisional engine computes a best answer through the following process:
filtering verbal stimuli by means of subjective NLP from the Loquor module (means for expressing);
translating non-verbal stimuli in textual descriptions from the Circum module (means for sensing);
recalling memories from the intuition engine;
finding and selecting memories that satisfy the stimuli through the use of semantic analysis based on texts, tags and/or descriptions; and
performing a computation to identify the best answer based on the selected memories.

21. The artificial intelligence platform of claim 1, wherein a decisional engine performs a computation to identify a best answer based on selected memories by comparing output of other logical elements with the following attributes of each selected memory:
the total level of intimacy;
the outputs of the Societas module (means for providing a level of intimacy); and
the outputs of the moral and ethical inferential engine.

22. The artificial intelligence platform of claim 21, wherein:
the total level of intimacy establishes which of the selected memories are compatible with the one or more interlocutors;
the outputs of the Societas module (means for providing a level of intimacy) allow it to obtain the emotional status of the artificial intelligence platform related to the multimodal inputs and related to each memory adopted as a possible answer; and
the outputs of the moral and ethical inferential engine permit it to recognize the moral and ethical values related to the multimodal inputs.

23. The artificial intelligence platform of claim 1, wherein the Loquor module (means for expressing) comprises a subjective natural language generation service.

24. The artificial intelligence platform of claim 23, wherein the subjective natural language generation service comprises:
a library of phonemes;
a library of facial expressions;
prosody maps;
idiom maps; and
jargon maps.
